(19) United States
(12) Patent Application Publication
(10) Pub. No.: US 2009/0023504 A1
(43) Pub. Date: Jan. 22, 2009

(54) Universal Joint with Wider Working Angle Range

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/867,794

(22) Filed: Oct. 5, 2007

(30) Foreign Application Priority Data
Jul. 18, 2007 (TW) 96126256

(51) Int. Cl. F16D 3/26

(52) U.S. Cl. 464/114

(57) ABSTRACT

A universal joint includes a pair of yoke members each having a pair of spaced arms. A coupler is pivotably coupled with the arms of the yoke members to allow the yoke members to respectively pivot about two pivot axes perpendicular to each other. Each arm includes two mutually facing inner faces and an intermediate face interconnected between the inner faces. Each arm further includes a pair of opposite lateral sides between which one of the inner faces extends. A recess is formed between each lateral side of each arm and one of the inner faces of one of the arms. The recesses of the arms of one of the yoke members allow entrance of the arms of the other yoke member.

### BACKGROUND OF THE INVENTION

The present invention relates to a universal joint and, more particularly, to a universal joint with a larger working angle range.

Various universal joints exist for providing power transmission from a power source to a member to be driven. FIGS. 6 and 7 show a conventional universal joint 90 including a pair of yoke members 93 and 95 and a coupler 91. The yoke member 95 includes a power input end 96, and the other yoke member 93 includes a power output end 97 for coupling with a socket. The coupler 91 includes a first through-hole 98 extending through a pair of opposite faces thereof and a second through-hole 99 extending through another pair of opposite faces thereof and orthogonal to but spaced from the first through-hole 98. The coupler 91 is pivotably coupled with the yoke member 93 by a first pin 92 extending through aligned pin holes 930 of the yoke member 93 and the first through-hole 98 of the coupler 91. Furthermore, the coupler 91 is pivotably coupled with the yoke member 95 by a second pin 94 extending through aligned pin holes 950 of the yoke member 95 and the second through-hole 99 of the coupler 91. The pivot axis of the first pin 92 does not intersect the pivot axis of the second pin 94. The working angle range of this universal joint is wider when the yoke member 95 is manually driven by the power input end 96. However, the distance A1 from the center O₂ of the second pin 94 to the center O₁ of the first pin 92 in the longitudinal direction L of the yoke member 93 changes continuously during operation such that the yoke member 95 continuously shakes up and down relative to the other yoke member 93 that is coupled with a socket for driving a fastener or the like. As a result, this universal joint 90 can only work through manual operation; i.e., this universal joint 90 is not suitable for high speed operation with a power tool.

FIGS. 8 and 9 show another conventional universal joint 80 including a pair of yoke members 83 and 85 and a cubic coupler 81. The yoke member 85 includes a power input end 86, and the other yoke member 83 includes a power output end 87 for coupling with a socket. The coupler 81 includes a through-hole 88 extending through a pair of opposite faces thereof and two holes 89 respectively in another pair of opposite faces thereof and orthogonal to but spaced from the through-hole 88. The coupler 81 is pivotably coupled with the yoke member 85 by a first pin 82 extending through the through-hole 88 of the coupler 81. Furthermore, the coupler 81 is pivotably coupled with the yoke member 83 by two second pins 84 respectively received in the holes 89 of the coupler 81. The pivot axis of the first pin 82 intersects and is perpendicular to the pivot axis of the second pins 84. The shaking problem of the conventional universal joint 90 of FIGS. 6 and 7 is avoided. Thus, this type of universal joint 80 can be utilized with high-speed power tools. However, the second pins 84 are liable to fall from the coupler 81 after a period of time due to high centrifugal force resulting from high speed rotation, leading to disengagement of the yoke member 85. Replacement of the pivotal structure of the universal joint 80 is not allowed if the second pins 84 are tightly fixed to the coupler 81 to avoid disengagement. Namely, the whole universal joint 80 must be discarded even though only a part of it is damaged. Furthermore, the maximum working angle (about 27.5°) of this universal joint 80 is smaller than that of the conventional universal joint 90 of FIGS. 6 and 7. Taiwan Patent Application Nos. 92220270 and 95216993 disclose similar devices and, thus, have similar disadvantages.

A need exists for a universal joint having a wider working angle range.

### BRIEF SUMMARY OF THE INVENTION

The present invention solves this need and other problems in the field of power transmission by providing, in a preferred form, a universal joint including a pair of yoke members. One of the yoke members includes a power input end, and the other yoke member includes a power output end. Each yoke member further includes a coupling end having a pair of spaced arms. A coupler is pivotably coupled with the arms of the yoke members to allow the yoke members to respectively pivot about two pivot axes perpendicular to each other. Each arm includes two mutually facing inner faces and an intermediate face interconnected between the inner faces. Each arm further includes a pair of opposite lateral sides between which one of the inner faces extends. A recess is formed between each lateral side of each arm and one of the inner faces of one of the arms. The recesses of the arms of one of the yoke members allow entrance of the arms of the other yoke member. Each recess is located between the intermediate face of one of the arms and one of the pivot axes.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a perspective view of a universal joint with a pivotal device according to the preferred teachings of the present invention.

FIG. 2 shows an exploded perspective view of the universal joint of FIG. 1.

FIG. 3 shows a cross sectional view of the universal joint of FIG. 1 according to section line 3-3 of FIG. 2.

FIG. 4 shows another perspective view of the universal joint of FIG. 1.

FIG. 5 shows a further perspective view of the universal joint of FIG. 1.

FIG. 6 shows an exploded perspective view of a conventional universal joint.

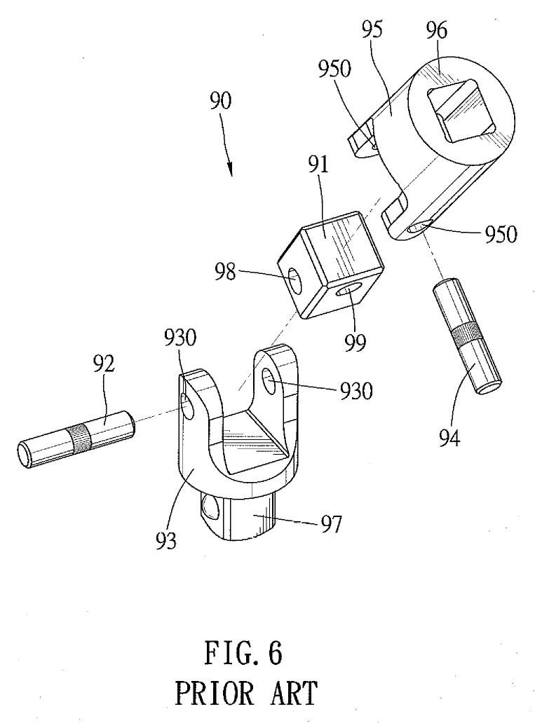

FIG. 7 shows a perspective view of the universal joint of FIG. 6.

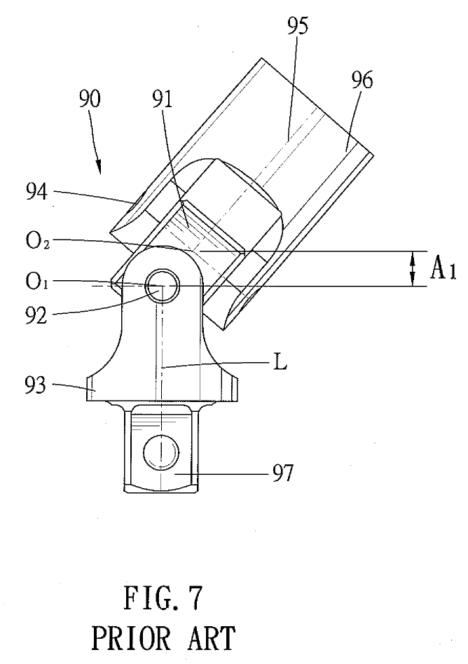

FIG. 8 shows a cross sectional view of another conventional universal joint.

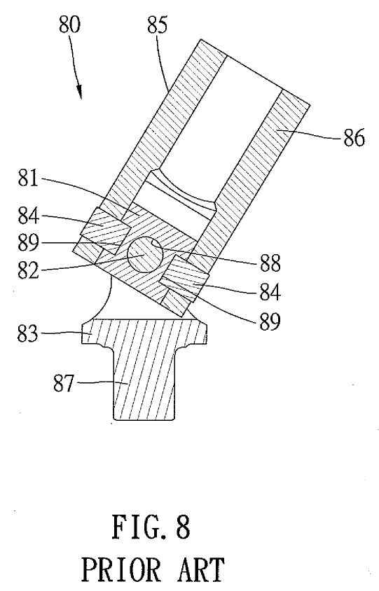

FIG. 9 shows a perspective view of the universal joint of FIG. 8.

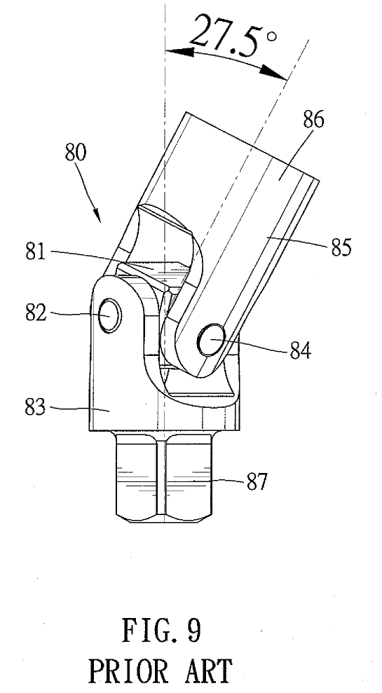

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “end”, “section”, “periphery”, “centrifugal”, “lateral”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

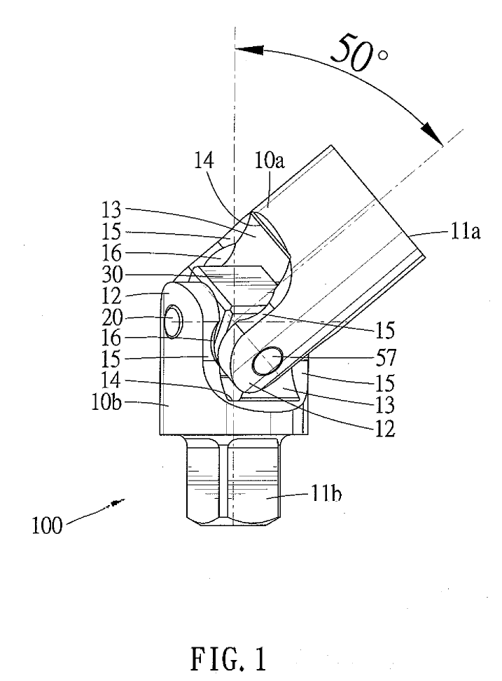

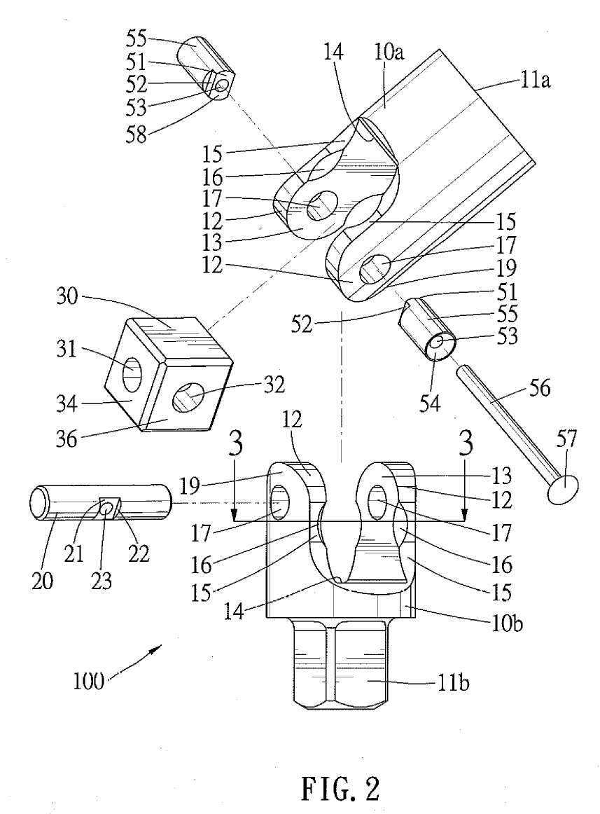

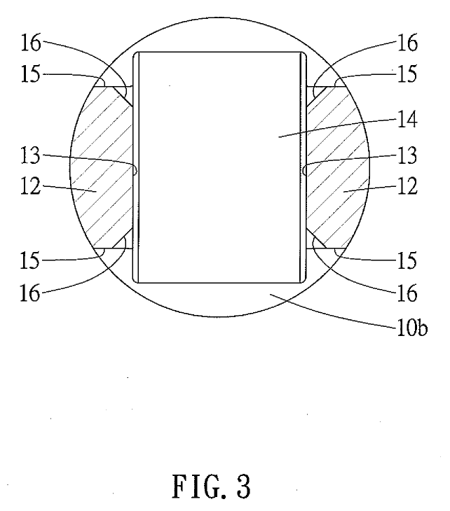

A universal joint according to the preferred teachings of the present invention is shown in FIGS. 1-5 of the drawings and designated 100. The universal joint 100 includes a pair of yoke members 10a and 10b. In the preferred form shown, the yoke member 10a includes a coupling end 19 and a power input end 11a in the form of a socket for coupling with a power tool for high speed operations. Other forms of the power input end 11a would be within the skill of the art. The yoke member 10b includes a coupling end 19 and a power output end 11b in the form of a drive column for coupling with a socket. Other forms of the power output end 11b would be within the skill of the art. In the most preferred form shown, the coupling ends 19 of the yoke members 10a and 10b are identical. Thus, description of one of the coupling ends 19 would be sufficient.

In the most preferred form shown, the coupling end 19 includes a pair of spaced arms 12 having aligned pivot holes 17 and mutually facing inner faces 13 interconnected by an intermediate face 14 therebetween. Each arm 12 further has two opposite lateral sides 15 between which one of the inner faces 13 extends. A recess 16 is formed between each lateral side 15 of each arm 12 and one of the inner faces 13 of the arm 12. Each recess 16 is located between the intermediate face 14 of one of the arms 12 and a pivot axis extending through the pivot holes 17. During transmission of power, the recesses 16 of each yoke member 10a, 10b receive the arms 12 of the other yoke member 10b, 10a. Thus, the angle between the yoke members 10a and 10b can be larger. Namely, the working angle range of the universal joint 100 according to the preferred teachings of the present invention is wider than conventional ones.

In the preferred form shown, the coupler 30 is a cube including a first pin hole 31 extending through a first pair of opposite faces 34 and a second pin hole 32 extending through a second pair of faces 36 perpendicular to the first pair of opposite faces 34. A first central axis extending through the first pin hole 31 is coplanar with and orthogonal to a second central axis extending through the second pin hole 32.

A first pin 20 includes two diametrically opposed grooves 21 in an outer periphery thereof and a transverse through-hole 23 extending through bottom walls of the grooves 21. The first pin 20 is extended through aligned pin holes 17 in the yoke member 10b and the first through-hole 31 of the coupler 30. Thus, the yoke member 10b is pivotable relative to the coupler 30 about a first pivot axis defined by the first pin 20. It is noted that the transverse through-hole 23 of the first pin 20 is aligned with the second through-hole 32 of the coupler 30.

A bushing 55 is extended through each pin hole 17 of the yoke member 10a into the second through-hole 32 of the coupler 30. Each bushing 55 includes an inner end 51 engaged in one of the grooves 21 of the first pin 20. In the preferred form shown, the inner end 51 of each bushing 55 includes a protrusion 58 fittingly received in one of the grooves 21 of the first pin 20. The protrusion 58 has two opposite outer faces 52 abutting with inner faces 22 of one of the grooves 21 of the first pin 20. Thus, rotational movement of the bushings 55 relative to the first pin 20 is avoided. Each bushing 55 further includes a longitudinal hole 53 having an enlarged section 54 in an outer end thereof. A second pin 56 in the preferred form shown as a rivet is extended through the longitudinal hole 53 in each bushing 55 and the transverse through-hole 23 of the first pin 20. Thus, the coupler 30 is pivotably coupled with the yoke member 10a. Formed on an end of the second pin 56 is an enlarged head 57 that is received in the enlarged section 54 of one of the bushings 55. The other end of the second pin 56 can be processed by hammering or pressing to form an enlarged head to be received in the enlarged section 54 of the other bushing 55 to prevent disengagement of the second pin 56 and the bushings 55. Thus, the yoke member 10a is pivotable relative to the coupler 30 about a second pivot axis defined by the second pin 56. The second pivot axis is perpendicular to and intersects the first pivot axis.

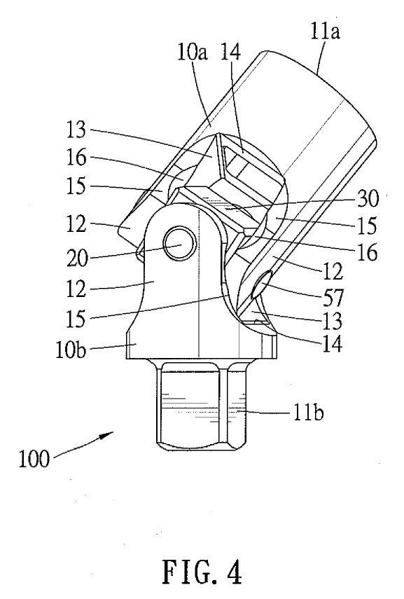

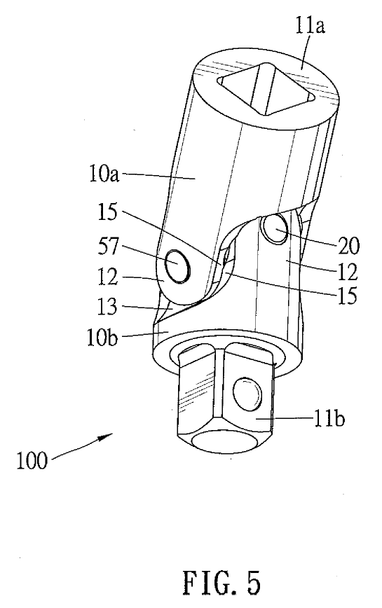

Now that the basic construction of the universal joint 100 of the preferred teachings of the present invention has been explained, the operation and some of the advantages of the universal joint 100 can be set forth and appreciated. When the power input end 11a of the yoke member 10a is rotated by a power tool, the power is transmitted to the yoke member 10b for driving a socket for tightening/loosening a fastener or the like. The recesses 16 of the arms 12 of one of the yoke members 10a and 10b can receive the arms 12 of the other yoke member 10a or 10b during power transmission (see FIGS. 4 and 5), allowing a larger maximum working angle between the yoke members 10a and 10b while allowing smooth operation and reducing interference between the yoke members 10a and 10b. The working angle range between the yoke members 10a and 10b is between 0 and 50 degrees (see FIG. 1), which is wider than conventional universal joints. Furthermore, shaking of the universal joint 100 is avoided, for the first and second pivot axes of the yoke members 10a and 10b are perpendicular to and intersect each other.

Now that the basic teachings of the present invention have been explained, many extensions and variations will be obvious to one having ordinary skill in the art. For example, the coupling ends 19 of the yoke members 10a and 10b can be different in shapes. The power input end 11a of the yoke member 10a can be manually driven or through a coupling member when desired. The yoke members 10a and 10b can be coupled with the coupler 30 by other pivotal arrangements, and modification of the coupler 30 according to different pivotal arrangements would be within the skill of the art.

Thus since the invention disclosed herein may be embodied in other specific forms without departing from the spirit or general characteristics thereof some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A universal joint comprising:
a pair of yoke members each including a coupling end, with one of the yoke members including a power input end, with the other yoke member including a power output end, with the coupling end of one of the yoke members including a pair of spaced first arms, with the coupling end of the other yoke member including a pair of spaced second arms; and
a coupler pivotably coupled with the first and second arms of the coupling ends of the yoke members, allowing the yoke members to respectively pivot about two pivot axes perpendicular to each other,
with the first arms including two mutually facing first inner faces and a first intermediate face interconnected between the first inner faces, with each of the first arms further including a first pair of opposite lateral sides between which one of the first inner faces extends, with a first recess being formed between each of the first pair of opposite lateral sides of each of the first arms and one of the first inner faces of one of the first arms, and with the first recesses of the first arms allowing entrance of the second arms.

2. The universal joint as claimed in claim 1, with each of the first recesses being located between the first intermediate face of one of the first arms and one of the pivot axes about which one of the yoke members having the first arms pivots.

3. The universal joint as claimed in claim 1, with the second arms including two mutually facing second inner faces and a second intermediate face interconnected between the second inner faces, with each of the second arms further including a second pair of opposite lateral sides between which one of the second inner faces extends, with a second recess being formed between each of the second pair of lateral sides of each of the second arms and one of the second inner faces of one of the second arms, and with the second recesses allowing entrance of the first arms.

4. The universal joint as claimed in claim 3, with each of the second recesses being located between the other pivot axis and the second intermediate face of one of the second arms.
